(19) United States
(12) Patent Application Publication
(10) Pub. No.: US 2017/0356701 A1
(43) Pub. Date: Dec. 14, 2017

(54) APPARATUS, SYSTEMS AND METHODS FOR PROTECTION AGAINST HIGH PRESSURE GAS INTRUSION IN SHELL AND TUBE HEAT EXCHANGERS

(71) Applicant: Chevron U.S.A. Inc., San Ramon, CA (US)

(72) Inventor: Joseph Bretch, Houston, TX (US)

(21) Appl. No.: 15/180,129

(22) Filed: Jun. 13, 2016

(51) Int. Cl. F28F 27/02; F16K 17/16; F16K 17/04; F28D 7/16; F28D 21/00

(52) U.S. Cl. CPC F28F 27/02; F16K 17/04; F28D 7/16; F16K 17/16; F28D 2021/0059; F28F 2265/12; F28F 2265/06

(57) ABSTRACT

Disclosed is an apparatus for use with shell and tube heat exchangers to protect the low-pressure side of the heat exchanger from overpressure in which one or more tubes fractures, allowing high-pressure gas to penetrate the low-pressure side. The apparatus includes a conduit for attachment to the low-pressure side of the heat exchanger and including a rupture disk therein that will rupture when subjected to a predetermined burst pressure. The conduit also includes a surge chamber located therein downstream of the rupture disk assembly, the surge chamber having dimensions resulting in a predetermined volume. A pressure relief valve is located at the downstream end of the conduit capable of opening in response to a pressure increase caused by fluids flowing through the conduit and closing in response to a pressure decrease. Also disclosed are systems and processes using the apparatus, and a method for retrofitting the exchangers with the apparatus.

### FIELD

The present disclosure relates to shell and tube type heat exchangers, and more particularly to an apparatus, and systems and methods using the apparatus, for protecting shell and tube type heat exchangers against high pressure gas intrusion in the event of a tube fracture.

### BACKGROUND

Conventional shell and tube type heat exchangers, such as those used in refineries, chemical processing and offshore oil and gas facilities, include a shell containing a shell side fluid and a plurality of tubes containing a tubeside fluid. Heat is exchanged between the shell side fluid and the tubeside fluid. In such heat exchangers, the shell side fluid or the tubeside fluid can be at a higher pressure, thus there is a high-pressure side (i.e., either the shell side or the tubeside) and a low-pressure side (i.e., the other side, either the shell side or the tubeside). Such heat exchangers frequently use rupture disks, also referred to as bursting disks, that burst at a predetermined pressure to protect the low-pressure side of the shell and tube heat exchanger from rapid transient pressure waves generated during a sudden tube rupture, also referred to as a guillotine fracture. Such ruptures, also referred to as overpressure incidents, can occur at various times including as a result of vibration, thermal shock, incorrectly installed or defective tube and/or corrosion of a tube. FIG. 1 illustrates such a shell and tube heat exchanger 10 in which the shell side is the low-pressure side having a section of conduit 21 including a bursting disk assembly 12 to protect against overpressure. The heat exchanger 10 has a shell 6 and a number of tubes 8. The heat exchanger 10 shown can be used, for example, to transfer heat between a high-pressure gas 2 and a low-pressure fluid 4. High-pressure gas 2 is fed through a gas inlet into the tubes 8. Low-pressure liquid medium 4 is fed through a shell inlet into the shell and surrounds the tubes 8. Alternatively, not shown, high-pressure gas can be fed into the shell surrounding the tubes while low-pressure fluid can be fed into the tubes. In a typical configuration, a bursting disk assembly 12 is used including a thin metal disk (bursting disk) 12A within a disk holder 12B that can take any suitable form such as, for example, a seat for the metal disk 12A located between two plates held in place by bolts and nuts. Conduit 15 leads to a closed disposal system 13. The closed disposal system 13 is intended for disposal of gas as may be necessary during normal operation. In the event of an overpressure incident, the low-pressure liquid medium 4 will be directed to the closed disposal system 13.

While bursting disks have a fast opening time to mitigate the pressure waves resulting from a sudden tube rupture, they also have several disadvantages. In certain applications, bursting disks are not practical since premature failure or opening of the bursting disk can occur potentially resulting in the entire cooling medium header being discharged into the closed disposal system 13. Such an event may impair the operability of the disposal system, e.g., a flare system, which could have serious safety consequences and lost product opportunity costs. In cases where a rupture disk assembly 12 cannot be utilized, the design pressure of the low pressure side must be increased such that fluid from the high pressure side cannot damage it. In practice, if the high pressure fluid stays below a hydrostatic test pressure of the low pressure side, it is assumed that no damage will occur and the possibility of an overpressure incident can be disregarded. Hydrostatic test pressure is typically 130% of the exchanger design pressure. Increasing the design pressure of an exchanger may require thicker shell plating, additional bolting materials, and larger piping flanges, all of which will undesirably add to the cost and weight of the exchanger installation. It would be desirable to have an alternative means for mitigating rapid transient pressure waves caused by sudden tube rupture in shell and tube heat exchangers that would avoid the aforementioned problems.

### SUMMARY

In one aspect, an apparatus is provided for protection against high pressure gas intrusion in the event of a tube fracture in a shell and tube heat exchanger having a shell and a plurality of tubes contained within the shell where the shell or the tubes normally contain low-pressure fluid and the shell or the tubes normally contain high-pressure fluid, such that there is a high-pressure side and a low-pressure side of the heat exchanger. The apparatus includes a conduit having a first end and a second and, the first end capable of being attached to the shell or the channel head in communication with the tubes, whichever contains the low-pressure fluid, such that the conduit is in fluid communication with the shell or channel head. The conduit also has a rupture disk assembly therein, the rupture disk assembly having a rupture disk conduit having a first face directed towards the first end of the conduit and a second face directed towards the second end of the conduit, the rupture disk formed from a material having a predetermined burst pressure such that the rupture disk will rupture when subjected to a pressure exceeding the predetermined burst pressure. The conduit also has a hydraulic surge chamber located in the conduit between the second face of the rupture disk and the second end of the conduit, the hydraulic surge chamber having a length and diameter resulting in a predetermined volume of the hydraulic surge chamber. The apparatus has a pressure relief valve located at the second end of the conduit capable of opening over time in response to a pressure increase caused by fluids flowing through the conduit as well as closing in response to a pressure decrease.

In another aspect, a system is provided for transferring heat between a high-pressure gas and a low temperature fluid using the shell and tube heat exchanger described above while protecting against high pressure gas intrusion in the event of a tube fracture in the heat exchanger. The first end of the conduit of the apparatus described above is connected to the low-pressure side of the heat exchanger, either to the shell or the channel head, whichever contains the low-pressure fluid.

In another aspect, a process is provided for transferring heat between a high-pressure gas and a low temperature fluid using the shell and tube heat exchanger described above while protecting against high pressure gas intrusion in the event of a tube fracture in the heat exchanger. The first end of the conduit of the apparatus described above is connected to the low-pressure side of the heat exchanger, either to the shell or the channel head, whichever contains the low-pressure fluid.

In yet another aspect, a process is provided for retrofitting a shell and tube heat exchanger having a shell, a plurality of tubes contained within the shell and an existing rupture disk assembly in communication with the low-pressure side of the heat exchanger and containing a rupture disk configured to burst at a predetermined burst pressure. The existing rupture disk assembly is replaced with the above-described apparatus for protection against high pressure gas intrusion in the event of a tube fracture in the heat exchanger. The process includes removing the existing rupture disk assembly from the heat exchanger, attaching the first end of the conduit of the above-described apparatus to the shell or channel head of the heat exchanger, whichever contains the low-pressure fluid, such that the conduit is in fluid communication with the low-pressure side of the heat exchanger, and connecting the pressure relief valve to a disposal system for disposal of liquid and/or gas.

### DESCRIPTION OF THE DRAWINGS

These and other objects, features and advantages of the present invention will become better understood with reference to the following description, appended claims and accompanying drawings. The drawings are not considered limiting of the scope of the appended claims. The elements shown in the drawings are not necessarily to scale. Reference numerals designate like or corresponding, but not necessarily identical, elements.

FIG. 1 is a simplified view illustrating a shell and tube heat exchanger according to the prior art.

FIG. 2 is a simplified view illustrating a shell and tube heat exchanger according to one exemplary embodiment.

FIGS. 3A-D are simplified views illustrating the operation of a shell and tube heat exchanger according to one exemplary embodiment.

FIG. 4 is a schematic diagram illustrating a method of retrofitting a shell and tube heat exchanger with an apparatus according to another embodiment.

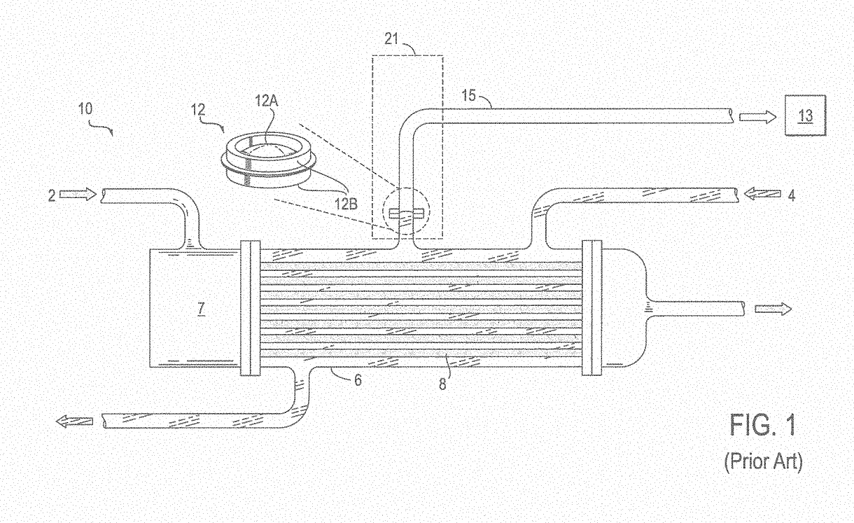

### DETAILED DESCRIPTION

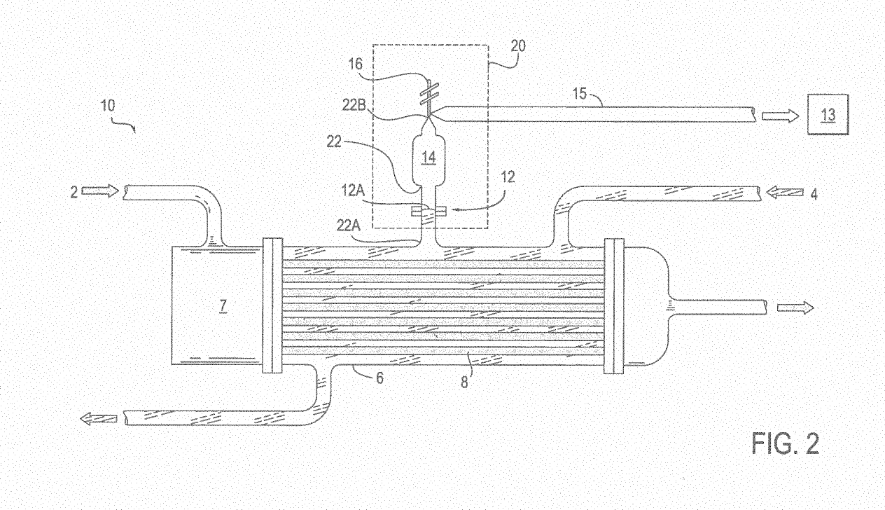

FIG. 2 illustrates a shell and tube heat exchanger according to one exemplary embodiment. In one embodiment, an apparatus 20, also referred to herein as a surge mitigation device 20, is provided for protection against high pressure gas intrusion in the event of a tube fracture in a shell and tube heat exchanger 10 having a shell 6 and a plurality of tubes 8 contained within the shell 6. The shell 6 or the tubes 8normally contain low-pressure liquid 4, also referred to herein as low-pressure fluid. Thus the shell side or the tubeside can be the low-pressure side. The other side, whichever of the shell side or the tubeside having a higher pressure, is then the high-pressure side. The low-pressure liquid 4 can be any suitable liquid such as glycol, water, oil, a refrigerant or mixtures thereof as would be apparent to one of ordinary skill in the art. In some embodiments, the low-pressure liquid is from 50 psig to 275 psig. Any fluid requiring a 150 pound flange rating can be considered low-pressure. The shell 6 or the tubes 8 can normally contain high-pressure gas 2. The high-pressure gas 2 can be, for example, hydrogen, hydrogen sulfide, methane, ethane, propane, natural gas and combinations thereof. In some embodiments, the high-pressure gas 2 is at a pressure of greater than 1000 psig. Such high-pressure gas can require 600 pound flange systems. The apparatus 20 includes a conduit 22 having a first end 22A to attach to the shell 6 or the channel head 7, whichever contains the low-pressure fluid, such that the conduit is in fluid communication with the low-pressure side and having a second end 22B, a rupture disk assembly 12 including a rupture disk 12A located in the conduit 22, the rupture disk having a first face directed towards the first end of the conduit and a second face directed towards the second end of the conduit. The rupture disk 12A is formed from a material having a predetermined burst pressure such that the rupture disk 12A will rupture when subjected to a pressure exceeding the predetermined burst pressure. A hydraulic surge chamber 14 is located in the conduit 22 between the rupture disk assembly 12 and the second end of the conduit 22B provided to negate or lessen any water hammering effect created by the sudden opening of the bursting disk. In one embodiment, the hydraulic surge chamber 14 is an integral part of the conduit 22, e.g., a bulge where the conduit diameter increases. The hydraulic surge chamber 14 has a length and diameter resulting in a predetermined volume of the hydraulic surge chamber 14. In one embodiment, the hydraulic surge chamber 14 has a diameter of from 3 inches to 12 inches. In one embodiment, the hydraulic surge chamber 14 has a volume of from 0.5 ft.³ to 2.5 ft.³

A pressure relief valve 16 is located at the second end of the conduit 22B and is capable of reversibly opening over time in response to a pressure increase caused by fluids flowing through the conduit 22, meaning that the relief valve 16 opens in response to a pressure increase caused by fluids flowing through the conduit 22, and closes in response to the pressure decreasing. The relief valve 16 can have a number of mechanical components including, for example, a spring (not shown) and a metal seat (not shown). In one embodiment, the pressure relief valve 16 is a spring loaded pressure relief valve having a spring controlling the position of a disk relative to a seat. In another embodiment, the pressure relief valve 16 is a pilot operated pressure relief valve having a piston and a remote pilot controlling the position of a disk relative to a seat.

In one embodiment, the pressure relief valve 16 is connected to a closed disposal system 13 that may include a storage tank, a vent or a flare system in fluid communication with the pressure relief valve. Gas passing through the pressure relief valve 16 can thus be collected and disposed of by any suitable method, such as storing temporarily, venting for flaring.

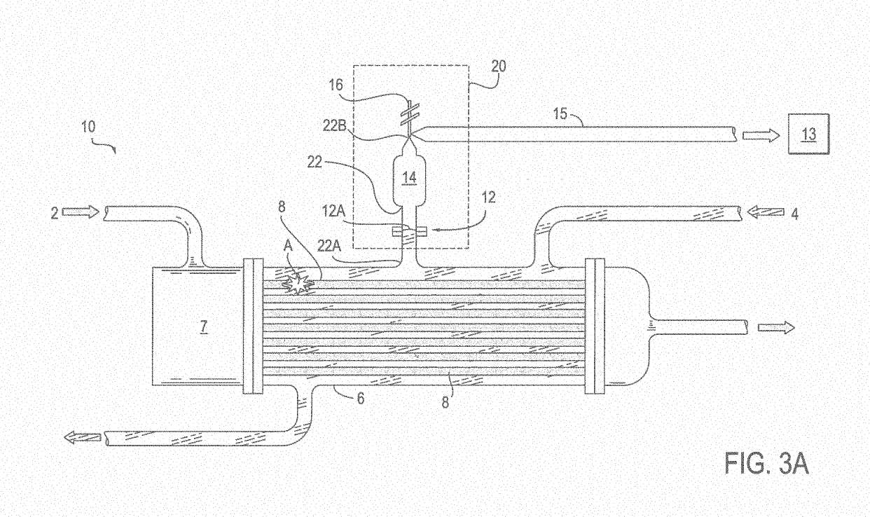

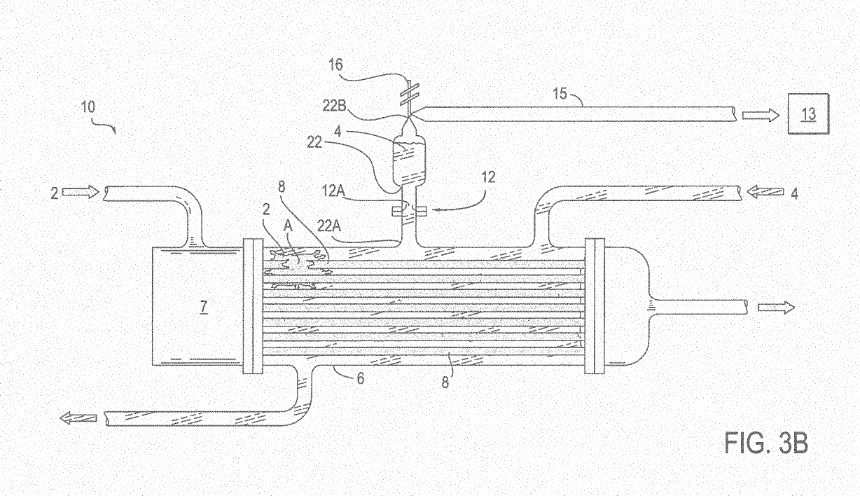

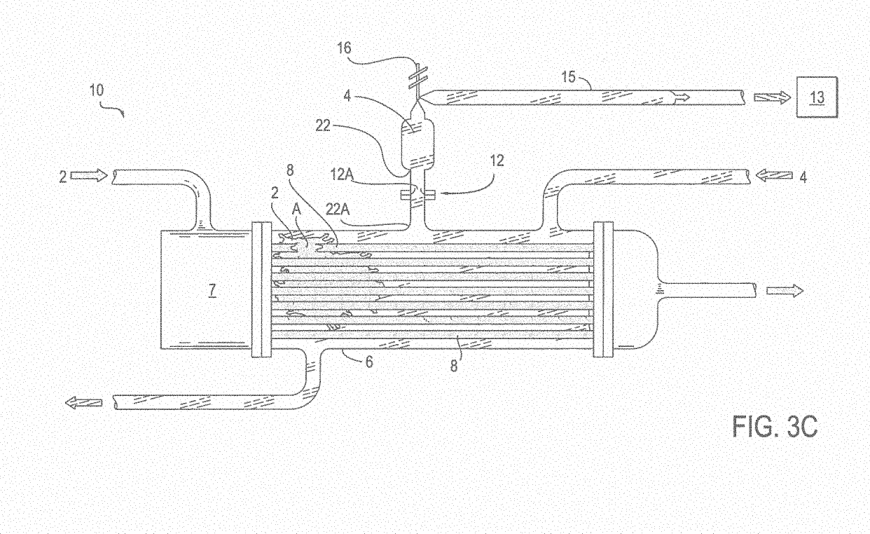

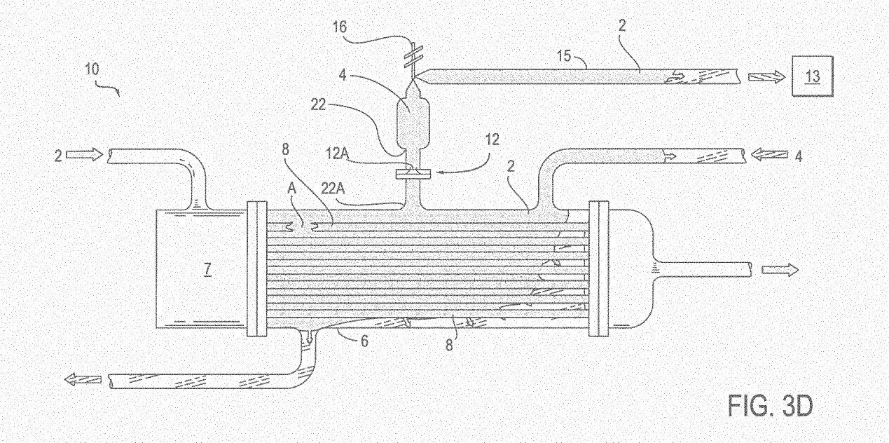

FIGS. 3A-D illustrate the operation of the shell and tube heat exchanger 10 utilizing the surge mitigation device 20 in which high-pressure gas is fed to the tubeside and low-pressure liquid is fed to the shell side. This is for illustration purposes only, and it is to be understood that the high-pressure gas could be fed to the shell side and the low-pressure liquid could be fed to the tubeside. FIG. 3A illustrates the initiation of an overpressure incident in which a tube 8 fractures at a location A. This can be a guillotine type fracture in the tube caused by vibration or corrosion. This results in a sudden, explosive pressure spike in the low-pressure side within the shell 6. As shown in FIG. 3B, as the high-pressure gas 2 expands from the point of the fracture A, gas 2 displaces liquid 4 and the low-pressure liquid 4 expands from the shell and into the surge mitigation device 20. The liquid 4 causes the rupture disk 12A to burst, and then expands into the surge chamber 14 where the liquid accumulates. At this point, the relief valve 16 has not yet deployed.

Upon further pressure increase in the surge mitigation device, the relief valve 16 opens. The relief valve 16 has a slower response or opening time than the bursting disk 12A, due to the relatively large number of mechanical components present in the relief valve 16. Sequential operation of these components is necessary to open the relief valve 16, i.e., in the case of a spring-loaded pressure relief valve, the spring must sense the pressure, compress, and lift the valve disk from the seat, etc. As shown in FIG. 3C, the relief valve 16 opens fully, allowing liquid 4 to pass into conduit 15. The transient pressure wave causes displaced liquid 4 to move through the relief valve 16 and the conduit 15, ultimately leading to a liquid storage drum (not shown). As shown in FIG. 3D, liquid 4 will be initially displaced in the low-pressure side (within the shell 6) of the heat exchanger 10. Gas 2 is sent through the relief valve 16 at steady-state conditions. Once the high pressure gas is isolated, pressure in the low pressure side will decrease and the pressure relief valve 16 will reseat or close in response to the pressure decrease.

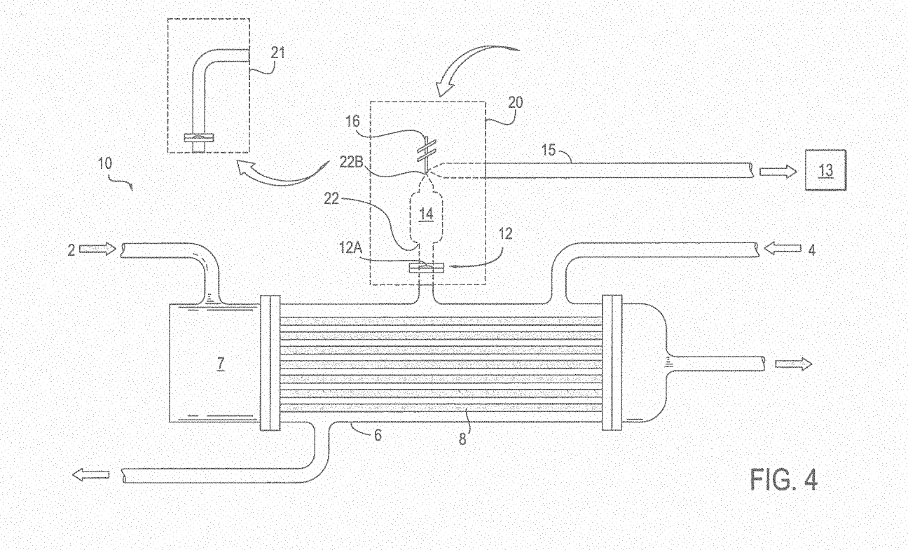

In one embodiment, an existing shell and tube heat exchanger 10 is retrofitted with the surge mitigation device 20. As shown in FIG. 4, the existing section of conduit 21 including the rupture disk assembly 12 can be removed from the shell 6 of the heat exchanger 10 such that an opening is provided accessible to the shell side of the heat exchanger 10. A first end of the conduit of the above-described surge mitigation device 20 is then attached to the shell 6 such that the conduit 22, including the rupture disk assembly 12 within the conduit 22, the surge chamber 14 and the relief valve 16, is in fluid communication with the interior of the shell 6. Lastly, the pressure relief valve 16 of the surge mitigation device 20 is connected to a disposal system for disposal of liquid and/or gas. In one embodiment, the existing section of conduit 21 including the rupture disk assembly 12 can remain in place and a new section of conduit 22 including a surge chamber 14 and a relief valve 16 can be installed. The disposal system (not shown) can include a knockout drum for liquids and/or a flare or vent for gases. In the embodiment shown, high-pressure gas is fed to the tubeside and low-pressure liquid is fed to the shell side. This is for illustration purposes only, and it is to be understood that the high-pressure gas could be fed to the shell side and the low-pressure liquid could be fed to the tubeside, in which case the surge mitigation device 20 would be attached to the channel head 7 (in turn in communication with the plurality of tubes) rather than the shell. By retrofitting existing refinery heat exchangers, in the event of overpressure incidents, rupture disks can be tied into a closed flare system, increasing safety and reliability.

Through the use of the surge mitigation device disclosed herein, overpressure protection can be provided to shell and tube heat exchangers such that lower pressure and lower cost exchangers can be used and validated from a safety and a pressure vessel coding perspective. This is because the surge mitigation device allows the low-pressure side of the heat exchanger to be rated for lower pressure while still ensuring safe operation, thus reducing the requirements for size, thickness, bolts, weight, materials and the like. Thus the use of the surge mitigation device allows safer operation at a lower cost (and reduced space and weight) for large shell and tube heat exchangers that are currently reliant on other means of overpressure protection such as higher design pressures or burst disks.

### EXAMPLE

An example of how the hydraulic surge chamber 14 can be sized will now be described. In this nonlimiting example, a volumetric flow rate of 12.8 ft³/s is assumed based on flow through a single 0.75″ tube located within a heat exchanger. In this case, the normal operating pressure of the high pressure side is 390 psig, and the maximum allowable accumulation pressure of the low pressure side is 82.5 psig. Thus, the pressure drop across the tube is 300 psig. The fluid composition is sour hydrogen gas used in a distillate hydrotreater reactor loop.

Assuming a typical opening time of the pressure relief valve 16 of 100 msec, the volume needed for the surge chamber 14 can be calculated as: 12.8 ft³/s×100 msec×(1 sec/100 msec)=1.28 ft³.

It should be noted that only the components relevant to the disclosure are shown in the figures, and that many other components normally part of a heat exchanger are not shown for simplicity.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

This written description uses examples to disclose the invention, including the best mode, and also to enable any person skilled in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

From the above description, those skilled in the art will perceive improvements, changes and modifications, which are intended to be covered by the appended claims.

What is claimed is:

1. An apparatus for protection against high pressure gas intrusion in the event of a tube fracture in a shell and tube heat exchanger comprising a shell and a plurality of tubes contained within the shell wherein either the shell or the tubes normally contain low-pressure liquid and the other of the shell or the tubes normally contain high-pressure gas, such that the shell and tube heat exchanger comprises a low-pressure side and a high-pressure side, the apparatus comprising:
a. a conduit having a first end configured to attach to the low-pressure side such that the conduit is in fluid communication with the low-pressure side and having a second end;
b. a rupture disk assembly located in the conduit, the rupture disk assembly including a rupture disk having a first face directed towards the first end of the conduit and a second face directed towards the second end of the conduit, the rupture disk formed from a material having a predetermined burst pressure such that the rupture disk will rupture when subjected to a pressure exceeding the predetermined burst pressure;
c. a hydraulic surge chamber located in the conduit between the second face of the rupture disk and the second end of the conduit, the hydraulic surge chamber having a length and diameter resulting in a predetermined volume of the hydraulic surge chamber; and
d. a pressure relief valve located at the second end of the conduit capable of opening over time in response to a pressure increase caused by fluids flowing through the conduit and closing in response to a pressure decrease.

2. The apparatus of claim 1, wherein the low-pressure side has a pressure of from 50 to 275 psig.

3. The apparatus of claim 1, wherein the high-pressure side has a pressure of at least 1000 psig.

4. The apparatus of claim 1, wherein the hydraulic surge chamber has a volume of from 0. 5 ft.³ to 2.5 ft.³

5. The apparatus of claim 1, wherein the hydraulic surge chamber has a diameter of from 3 inches to 12 inches.

6. The apparatus of claim 1, wherein the pressure relief valve comprises a spring loaded pressure relief valve or a pilot operated pressure relief valve.

7. A system for transferring heat between a high-pressure gas and a low-pressure liquid using a shell and tube heat exchanger while protecting against high pressure gas intrusion in the event of a tube fracture in the heat exchanger, comprising:
a. a shell and tube heat exchanger comprising a shell and a plurality of tubes contained within the shell wherein either the shell or the tubes normally contain low-pressure liquid and the other of the shell or the tubes normally contain high-pressure gas, such that the shell and tube heat exchanger comprise a low-pressure side and a high-pressure side;
b. a conduit having a first end configured to attach to the low-pressure side such that the conduit is in fluid communication with the low-pressure side and having a second end;
c. a rupture disk assembly located in the conduit, the rupture disk assembly including a rupture disk conduit having a first face directed towards the first end of the conduit and a second face directed towards the second end of the conduit, the rupture disk formed from a material having a predetermined burst pressure such that the rupture disk will rupture when subjected to a pressure exceeding the predetermined burst pressure;
d. a hydraulic surge chamber located in the conduit between the second face of the rupture disk and the second end of the conduit, the hydraulic surge chamber having a length and diameter resulting in a predetermined volume of the hydraulic surge chamber; and
e. a pressure relief valve located at the second end of the conduit capable of opening over time in response to a pressure increase caused by fluids flowing from the low-pressure side of the shell and tube heat exchanger through the conduit and closing in response to a pressure decrease.

8. The system of claim 7, further comprising a closed disposal system comprising a storage tank, a vent or a flare system in fluid communication with the pressure relief valve.

9. The system of claim 7, further comprising a flare system in fluid communication with the pressure relief valve.

10. The system of claim 7, wherein the low-pressure side has a pressure of from 50 to 275 psig.

11. The system of claim 7, wherein the high-pressure side has a pressure of at least 1000 psig.

12. The system of claim 7, wherein the hydraulic surge chamber has a volume of from 0.5 ft.³ to 2.5 ft.³

13. The system of claim 7, wherein the hydraulic surge chamber has a diameter of from 3 inches to 12 inches.

14. The system of claim 7, wherein the pressure relief valve comprises a spring loaded pressure relief valve or a pilot operated pressure relief valve.

15. A process for transferring heat between a high-pressure gas and a low-pressure liquid in a shell and tube heat exchanger, wherein the shell and tube heat exchanger comprises a shell and a plurality of tubes contained within the shell wherein either the shell or the tubes normally contain the low-pressure liquid and the other of the shell or the tubes normally contain the high-pressure gas, such that the shell and tube heat exchanger comprise a low-pressure side and a high-pressure side, while protecting against high pressure gas intrusion in the event of a tube fracture in the shell and tube heat exchanger, comprising:
a. providing an apparatus comprising:
i. a conduit having a first end attached to the low-pressure side of the heat exchanger such that the conduit is in fluid communication with the low-pressure side and having a second end;
ii. a rupture disk assembly located in the conduit wherein the rupture disk assembly comprises a rupture disk having a first face directed towards the first end of the conduit and a second face directed towards the second end of the conduit, the rupture disk formed from a material having a predetermined burst pressure such that the rupture disk will rupture when subjected to a pressure exceeding the predetermined burst pressure;
iii. a hydraulic surge chamber located in the conduit between the second face of the rupture disk and the second end of the conduit, the hydraulic surge chamber having a length and diameter resulting in a predetermined volume of the hydraulic surge chamber; and
iv. a pressure relief valve located at the second end of the conduit capable of opening over time in response to a pressure increase caused by fluids flowing from the low-pressure side of the shell and tube heat exchanger through the conduit and closing in response to a pressure decrease;
b. flowing the high-pressure gas into the high-pressure side; and
c. flowing a low-pressure liquid into the low-pressure side;
wherein during normal operation, the high-pressure gas in the high-pressure side is separated from the low-pressure liquid in the low-pressure side and heat is transferred between the high-pressure gas and the low-pressure liquid; and
wherein, in the event of a fracture of at least one tube in the heat exchanger, pressure within the low-pressure side will increase thereby causing the rupture disk to rupture, the hydraulic surge chamber to fill with fluid from the low-pressure side, and the pressure relief valve to open over time in response to a pressure increase caused by fluids flowing from the low-pressure side of the shell and tube heat exchanger through the conduit as a result of the fracture.

16. The process of claim 15, wherein the high-pressure gas is selected from the group consisting of hydrogen, hydrogen sulfide, methane, ethane, propane, natural gas and combinations thereof.

17. The process of claim 15, wherein the low-pressure liquid is selected from the group consisting of glycol, water, oil, a refrigerant and mixtures thereof.

18. The process of claim 15, further comprising flowing gas from the pressure relief valve to a closed disposal system comprising a storage tank, a vent or a flare system.

19. The process of claim 15, further comprising flowing gas from the pressure relief valve to a flare system in fluid retention with the pressure relief valve.

20. The process of claim 15, wherein the low-pressure side has a pressure of from 50 to 275 psig.

21. The process of claim 15, wherein the high-pressure side has a pressure of at least 1000 psig.

22. The process of claim 15, wherein the hydraulic surge chamber has a volume of from 0.5 ft.³ to 2.5 ft.³

23. The process of claim 15, wherein the hydraulic surge chamber has a diameter of from 3 inches to 12 inches.

24. The process of claim 15, wherein the pressure relief valve comprises a spring loaded pressure relief valve or a pilot operated pressure relief valve.

25. A process for retrofitting a shell and tube heat exchanger comprising a shell and a plurality of tubes contained within the shell wherein either the shell or the tubes normally contain the low-pressure liquid and the other of the shell or the tubes normally contain the high-pressure gas, such that the shell and tube heat exchanger comprise a low-pressure side and a high-pressure side and an existing rupture disk in fluid communication with the low-pressure side configured to burst at a predetermined burst pressure with an apparatus for protection against high pressure gas intrusion in the event of a tube fracture in the heat exchanger, comprising:
a. removing the existing rupture disk from the heat exchanger;
b. attaching the first end of the conduit of the apparatus of claim 1 to the low pressure side of the heat exchanger such that the conduit is in fluid communication with the low-pressure side of the heat exchanger; and
c. connecting the pressure relief valve to a disposal system for disposal of liquid and/or gas.
